(19) United States
(12) Patent Application Publication
(10) Pub. No.: US 2026/0357852 A1
(43) Pub. Date: Nov. 12, 2026

(54) THIN SECTION BEARING UNIT

(71) Applicant: Aktiebolaget SKF, Goteborg (SE)

(72) Inventors: Andrea A BERTOLINI, Luni (IT); Fausto BARACCA, Massa (IT); Michele MAGGI, Capezzano Pianore (IT)

(21) Appl. No.: 19/668,115

(22) Filed: May 5, 2026

(30) Foreign Application Priority Data
May 12, 2025 (IT) 102025000010605

(51) Int. Cl. F16C 33/78; F16C 19/06

(52) U.S. Cl. CPC F16C 33/7853; F16C 19/06; F16C 2208/10

(57) ABSTRACT

A thin section bearing unit (30) has a central rotation axis (X), a stationary radially outer ring (31), a rotatable radially inner ring (34), and a sealing device (50) mounted between the radially outer ring (31) and the radially inner ring (34). The sealing device (50) has a shield (60) and a sealing element (70) stably fixed to the shield (60). The sealing element (70) has an end portion (73) with a first lip (74) and a second lip (75). Both of the two non-contacting lips (74, 75) protrude towards a cylindrical surface (34a) of the radially inner ring (34). The first lip (74) protrudes in an oblique direction radially inwards and axially towards the outside. The second lip (75) protrudes in an oblique direction radially inwards and axially inwards.

### CROSS REFERENCE TO RELATED APPLICATION

This application claims priority to Italian Patent Application No. 102025000010605, filed May 12, 2025, the entirety of which is hereby incorporated by reference.

### FIELD

The present disclosure relates to a bearing unit of thin section.

This present disclosure specifically relates to a thin section bearing unit, such as those used in multi-wire machines for marble processing, to which the present description refers, while remaining broadly applicable.

### BACKGROUND

Known thin section bearing units used in multi-wire machines feature a central rotation axis defined by the support shaft, relatively large external diameters, and significantly reduced axial thicknesses. The combination of large diameters and reduced axial thicknesses makes it essential to use highly sophisticated technical solutions to ensure consistently high performance.

These bearing units comprise:
respective rotatable inner rings,
respective stationary outer rings,
a ring of rolling elements, preferably balls, interposed between the inner and outer rings to enable their relative rotation, the rolling elements being held in place by a stamped steel retaining cage that surrounds the rolling elements on both axially opposing sides of the ring; and
respective sealing shields arranged on the axially opposing sides of the ring of rolling elements and interposed between the related inner and outer rings, both to prevent the ingress of contaminants, such as water mixed with stone dust, into the bearing units, and to prevent the internal lubricating grease from leaking out.

Sealing devices for bearing units come in a variety of configurations. According to a known technique, the sealing device is made as a single piece. This configuration is used both for stationary outer rings and rotatable inner rings, and for rotatable outer rings and stationary inner rings. The key point is that the stationary ring be provided with a housing groove. This is the case, for example, with thin bearing units that use balls as rolling bodies.

The sealing device may comprise a single metal shield that does not come into contact with the rotatable ring, thus preventing metal-on-metal contact.

Alternatively, the sealing device may include a metal shield on which an elastomeric sealing element is co-moulded. The sealing element is provided with a radially outer lip that is interference fitted into a housing groove of the stationary ring of the bearing unit, for example the radially outer ring. The radially outer lip of the elastomeric sealing element is therefore integral with the outer ring and provides the seal with that component by virtue of the interference fit. The sealing element is also provided with at least one radially inner lip.

Preferably, this lip may be contacting and, according to this embodiment, form a sliding contact with the rotatable ring of the bearing unit, for example the radially inner ring, making the seal with the latter.

Alternatively, the lip may be non-contacting with respect to the rotatable ring. In this latter embodiment, the lip forms a “labyrinth”. Such labyrinths are used both with rotatable radially outer rings and with rotatable radially inner rings. However, the first type is more effective, as the centrifugal force related to the angular velocity of the rotatable ring tends to push the contaminant towards the outside of the bearing unit.

In any case, the typical design of a sealing device therefore comprises one or more projections referred to as lips, having different shapes and orientations (typically axial and radial), which are in contact with surfaces of the rotary bearing unit. The sealing device thus prevents contaminants from entering from the outside, protecting the internal components of the bearing unit, i.e. the rolling bodies and the containment cages for said rolling bodies. Another important function of a sealing device is to prevent the egress of lubricants present inside the bearing unit.

A technical problem of the thin section bearing units is to ensure excellent protection against external contaminants without increasing friction torque. None of the known solutions, including those with non-contacting lips, have achieved this optimal trade-off.

### SUMMARY

The present disclosure is intended to provide a thin section bearing unit that addresses the aforementioned issue by incorporating a non-contacting sealing device in order to minimize friction torque.

The present disclosure provides a thin section bearing unit for multi-wire machines having the features set out in the attached claims.

### BRIEF DESCRIPTION OF THE DRAWINGS

The present disclosure is described below with reference to the attached drawings illustrating a non-limiting example embodiment thereof, in which:

FIG. 1 illustrates, in cross section, a thin section bearing unit according to a preferred embodiment of the present disclosure,

FIG. 2 illustrates, in cross section and on an enlarged scale, a sealing device of the bearing unit in FIG. 1, and

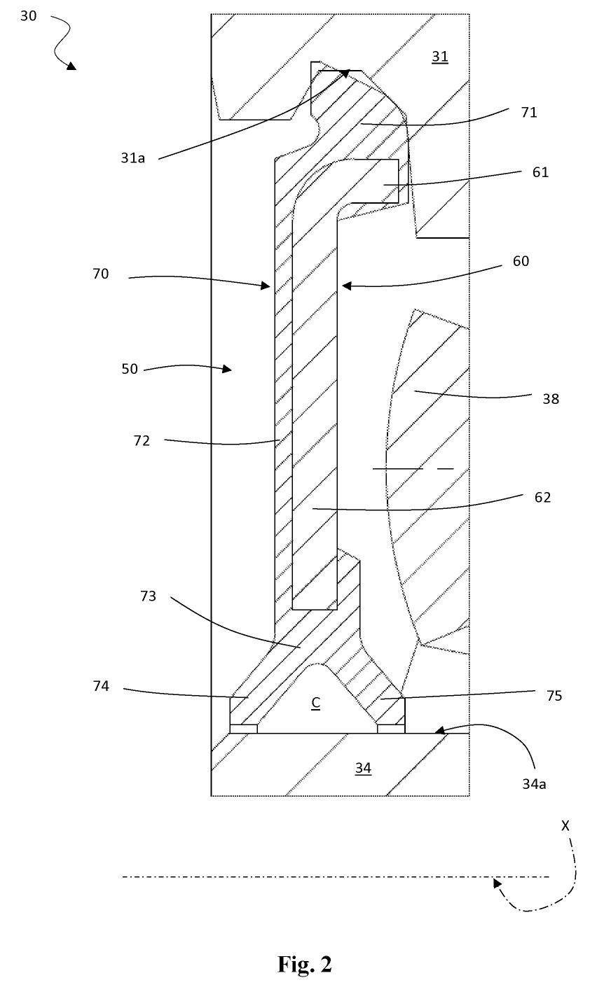

FIG. 3 shows a detail, in cross section and on an even more enlarged scale, of the sealing device in FIG. 2.

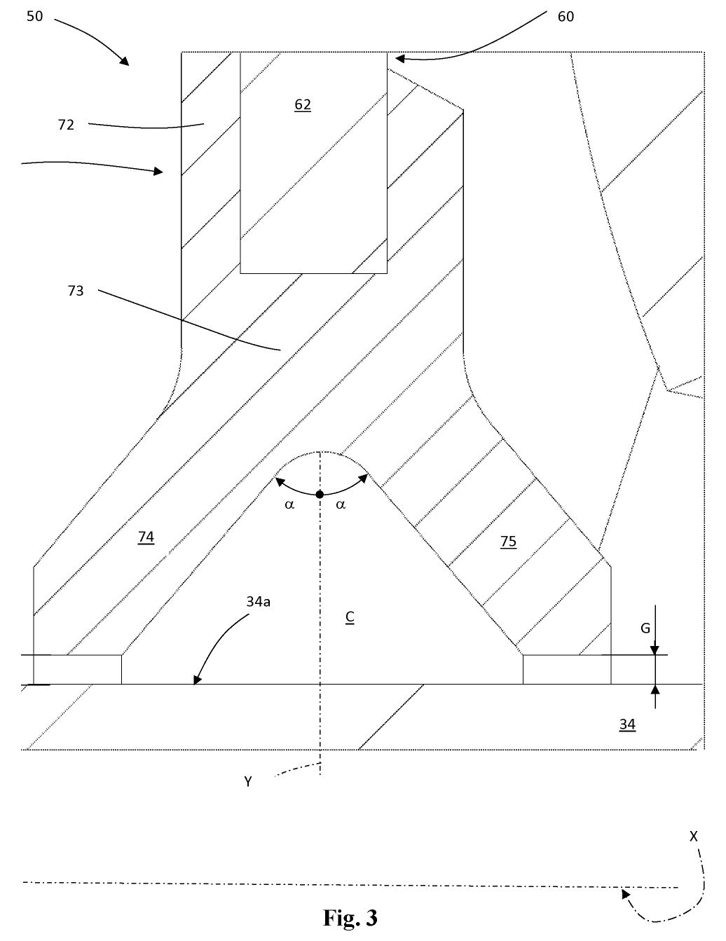

### DETAILED DESCRIPTION

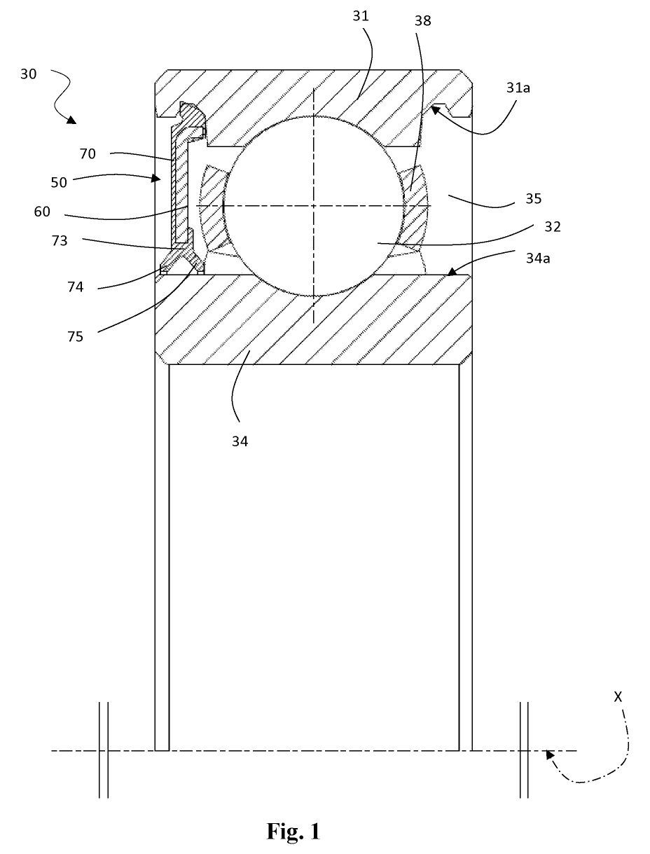

In FIG. 1, reference sign 30 denotes a thin section bearing unit as a whole.

The thin section bearing unit 30 of the present disclosure can advantageously be used in multi-wire machines for processing marble, but it can also for example be applied to other types of machinery, while remaining broadly applicable.

The bearing unit 30 has a central rotation axis X, and comprises:
a stationary radially outer ring 31 provided with a radially inner housing groove 31a,
a rotatable radially inner ring 34,
a plurality of rolling bodies 32, in this case balls, interposed between the radially outer ring 31 and the radially inner ring 34,
at least one cage 38 for containing and retaining the plurality of rolling bodies 32.

Throughout the present description and in the claims, terms and expressions indicating positions and orientations, such as “radial” and “axial”, are to be understood with reference to the central axis X of rotation of the bearing unit 30.

On the other hand, expressions such as “axially outer” and “axially inner” refer to the sealing device when mounted in the bearing unit, and in this case preferably refer to an insertion side via which the sealing device is inserted into the housing groove of the radially outer ring and to a side opposite the insertion side, respectively.

The radially outer ring 31 and the radially inner ring 34 together define a space 35 which, if unshielded, would allow contaminants and impurities to enter the bearing unit 30.

Therefore, in order to shield the bearing unit 30, at least one sealing device 50 according to the present disclosure is mounted inside the space 35.

The sealing device 50 comprises a shaped shield 60 preferably made of sheet metal , and a sealing element 70 made of elastomeric material stably fixed to the shield 60 by means of a vulcanization process to form a single body with the shield.

The shield 60 comprises a radially outer cylindrical portion 61 and a flange portion 62, connected to the cylindrical portion 61 and which protrudes radially inwards towards the radially inner ring 34.

The sealing element 70 in turn comprises:
a radially outer anchoring portion 71, supported by the cylindrical portion 61 of the shield 60, which can be interference fitted, by being deformed, into the housing groove 31a of the radially outer ring 31,
an intermediate portion 72, supported by the flange portion 62 of the shield 60 and connected to the anchoring portion 71, from which it protrudes radially inwards,
a radially inner end portion 73 connected to the intermediate portion 72 and comprising a first lip 74 and a second lip 75. Both of the lips 74, 75 protrude towards a cylindrical surface 34a of the radially inner ring 34 but are non-contacting. Specifically, the first lip 74 protrudes obliquely radially inwards and axially outwards, while the second lip 75 protrudes obliquely radially inwards but axially inwards. The end portion 73 of the sealing element 70 comprising the two lips 74, 75 therefore forms an inverted “V” shape, and a chamber C is defined between the first lip 74, the second lip 75 and the surface 34a of the radially inner ring 34. Preferably, the two lips 74, 75 are symmetrical with respect to an axis Y orthogonal to the central rotation axis X.

The presence of two non-contacting lips 74, 75 improves the performance of the seal compared to known single-lip solutions, both in preventing external contaminants from entering the bearing unit, and in keeping the lubricating grease inside the bearing unit. Furthermore, since both lips are non-contacting, there is no increase in friction torque, unlike known solutions with one or more contacting lips.

At the same time, in order to improve sealing performance, it is important to minimize the radial distance G between the lips 74, 75 and the surface 34a of the radially inner ring 34. Preferably, the radial distance G should not exceed 0.1 mm, and should even more preferably be 0.05 mm. This approach results in a solution with non-contacting lips that is nonetheless very similar to a contacting solution. The lips 74 and 75 can be brought as close as possible to the radially inner ring 34 because the radial clearance of the bearing unit 30 is negligible, in the order of 10/20 microns.

The present solution is significantly better than other known non-contacting solutions featuring an elastomeric sealing element with a very large, flat surface that faces the radially inner ring because the radial distance G is much smaller, and any contact between the lips and the radially inner ring results in a negligible increase in friction torque. Conversely, in the known solution with a large flat surface, any contact between the sealing element and the radially inner ring results in a significant increase in friction torque.

The present solution also outperforms a known solution provided with a single metal shield. In fact, while the present solution allows the non-contacting lips to get as close as possible to the radially inner ring, in the solution that uses a single metal shield, the radial distance between the shield and the radially inner ring is significantly greater to prevent any metal-to-metal contact, which results in inferior sealing performance.

The symmetrical design saves space in terms of the overall axial width of the bearing unit, as it allows for a small axial footprint both inside and outside the metal shield 60. The symmetrical design solution is made possible by the presence of the sealing element with two non-contacting lips. In the known solution that uses only a metal shield, for example, this symmetrical design is not possible because the manufacturing process of a stamped metal sheet requires the design to be formed in only one direction.

The inverted “V” shape of the end portion 73 comprising the two lips 74, 75 and the thinness of the two lips provides the two lips 74, 75 with significant flexibility, enabling them to be deformed by the contaminants. Specifically, both lips 74, 75 are deformed axially inwards due to the pressure exerted by external contaminants, temporarily grazing or even touching the cylindrical surface 34a of the radially inner ring 34.

This effect also helps to increase the protection provided by the bearing unit against external contaminants. Additionally, the deflection of the two lips 74, 75 improves containment of the lubricating grease and pushes the grease back to where it is most needed, namely towards the raceways.

Preferably, the angle α formed by each lip 74, 75 with the symmetry axis Y is between 30° and 60°, for example 45°. Values below 30° would excessively reduce the volume of the chamber C between the two lips, thereby limiting their ability to deform and move as close as possible to the cylindrical surface 34a of the radially inner ring 34. At the same time, it is not advisable to exceed 60° as the total axial width of the sealing device 50 as a whole also increases as the angle α increases.

The presence of the chamber C between the two lips 74, 75 enables the chamber C to be filled with fresh lubricating grease. This additional lubricating grease provides extra protection for the bearing unit by creating an additional barrier against external contaminants, in the event of the contaminants getting past the outer axial lip 74. Advantageously, the quantity of grease is between 60% and 80% of the free volume of the chamber C to ensure good protection.

Additionally, the grease in the chamber C lubricates any temporary contact between the lips 74, 75 and the radially inner ring 34, thereby reducing the friction torque caused by temporary contact.

Ultimately, using a bearing unit according to the present disclosure offers numerous advantages:
increased service life of the bearings,
enhanced protection against contaminants and enhanced performance of the sealing system,
does not require any changes to the geometry of the bearing unit,
reduced friction torque,
uses the same anchoring as known sealing devices,
simple assembly process,
prevents grease losses.

Numerous other variants exist in addition to the embodiments of the present disclosure described above. Said embodiments are provided solely by way of example and do not limit the scope of the present disclosure, its applications or its possible configurations. Indeed, although the description provided above enables the person skilled in the art to carry out the present disclosure at least according to one example configuration thereof, numerous variations of the components described could be used without thereby departing from the scope of the present disclosure, as defined in the attached claims interpreted literally and/or according to their legal equivalents.

What is claimed is:

1. A thin section bearing unit having a central rotation axis, the bearing unit comprising:
a stationary radially outer ring;
a rotatable radially inner ring having a cylindrical surface; and
a sealing device mounted in a space defined between the radially outer ring and the radially inner ring, the sealing device comprising:
a shield made of sheet metal; and
a sealing element made of elastomeric material stably fixed to the shield, the sealing element having a radially inner end portion including a first non-contacting lip and a second non-contacting lip, the first and second non-contacting lips protruding towards the cylindrical surface of the radially inner ring, the first lip protruding in an oblique direction radially inwards and axially towards the outside, and the second lip protruding in an oblique direction radially inwards and axially inwards.

2. The bearing unit according to claim 1, wherein a radial distance between the first and second non-contacting lips and the cylindrical surface of the radially inner ring does not exceed 0.1 mm.

3. The bearing unit according to claim 1, wherein the first and second non-contacting lips are symmetrical with respect to a symmetry axis orthogonal to the central rotation axis.

4. The bearing unit according to claim 3, wherein the angle formed by each of the first and second non-contacting lips with the symmetry axis is between 30° and 60°.

5. The bearing unit according to claim 1, wherein a chamber is defined between the first non-contacting lip, the second non-contacting lip, and the cylindrical surface of the radially inner ring.

6. The bearing unit according to claim 5, wherein the chamber contains a quantity of lubricating grease filling between 60% and 80% of the free volume of the chamber.

7. The bearing unit according to claim 1, wherein the shield comprises a radially outer cylindrical portion and a flange portion connected to the cylindrical portion, the flange portion protruding radially inward towards the radially inner ring.

8. The bearing unit according to claim 1, wherein the sealing element comprises:
a radially outer anchoring portion supported by the cylindrical portion of the shield, the radially outer anchoring portion being deformed and interference fitted into a housing groove of the radially outer ring; and
an intermediate portion supported by the flange portion of the shield, the intermediate portion being connected to the anchoring portion and to the end portion, the intermediate portion protruding radially inwards from the anchoring portion.

9. The bearing unit according to claim 2, wherein the first and second non-contacting lips are symmetrical with respect to a symmetry axis orthogonal to the central rotation axis.

10. The bearing unit according to claim 9, wherein the angle formed by each of the first and second non-contacting lips with the symmetry axis is between 30° and 60°.

11. The bearing unit according to claim 10, wherein a chamber is defined between the first non-contacting lip, the second non-contacting lip, and the cylindrical surface of the radially inner ring.

12. The bearing unit according to claim 11, wherein the chamber contains a quantity of lubricating grease filling between 60% and 80% of the free volume of the chamber.

13. The bearing unit according to claim 12, wherein the shield comprises a radially outer cylindrical portion and a flange portion connected to the cylindrical portion, the flange portion protruding radially inward towards the radially inner ring.

14. The bearing unit according to claim 13, wherein the sealing element comprises:
a radially outer anchoring portion supported by the cylindrical portion of the shield, the radially outer anchoring portion being deformed and interference fitted into a housing groove of the radially outer ring; and
an intermediate portion supported by the flange portion of the shield, the intermediate portion being connected to the anchoring portion and to the end portion, the intermediate portion protruding radially inwards from the anchoring portion.
